(19) United States
(12) Patent Application Publication
(10) Pub. No.: US 2001/0032392 A1
(43) Pub. Date: Oct. 25, 2001

(54) Handle of cutting device

(75) Inventors: Masayuki Ueno, Seki-shi (JP); Kiyoshi Ido, Seki-shi (JP)

Correspondence Address: Robert D. Buyan, Stout, Uxa, Buyan & Mullins, LLP, Suite 300, 4 Venture, Irvine, CA, 92618, US

(73) Assignee: Feather Safety Razor Co., Ltd.

(21) Appl. No.: 09/829,522

(22) Filed: Apr. 10, 2001

(30) Foreign Application Priority Data
Apr. 13, 2000 (JP) 2000-111812

(51) Int. Cl. B26B 13/12

(52) U.S. Cl. 30/345; 30/256; 30/254

(57) ABSTRACT

A handle of a cutting device is formed of shape memory resin. The handle has an assisting portion that makes it easy to reshape the handle.

### BACKGROUND OF THE INVENTION

The present invention relates to handles of cutting devices, and, more particularly, to handles of cutting devices that are molded from shape memory resin.

Typically, handles of cutting devices are fabricated through mass production. However, since a mass-produced handle has a standardized shape and dimensions, the product may not fit a user's hand.

Accordingly, there have been proposed handles of cutting devices that are formed of shape memory resin. More specifically, a handle is molded from shape memory resin and is reshaped at a temperature greater than a use temperature range, which is a temperature range in which the cutting device is actually used. The reshaped handle maintains its shape as long as the temperature remains in the use temperature range. In other words, a user can freely reshape the handle as desired, even though the handle has been fabricated through mass production. As a result, the reshaped handle of the cutting device fits the user's hand, like a customized product.

For example, Japanese Unexamined Utility Model Publication No. 6-26769 (hereinafter referred to as “a first prior art example”) and Japanese Unexamined Patent Publication No. 7-285084 (hereinafter referred to as “a second prior art example”) each describe a handle of a cutting device. The handle is formed of shape memory resin. The handle of the first prior art example is solid, and the entire surface of the handle is flat. A finger support hole is formed in a base of the handle such that a user can hold the handle with a finger held in the support hold. The handle of the second prior art example has a metal core and a coating that encompasses the core. The coating is formed of shape memory resin. This handle is reshaped as desired by reshaping the coating, which encompasses the core.

However, as described, the handle of the first prior art example is solid and has a flat surface, and the thickness (the cross-sectional area) of the handle is relatively large. Accordingly, when the handle is heated and reshaped, reactive force acts against reshaping, thus hampering the reshaping. In addition, when the handle is formed through, for example, injection molding, a shrinkage cavity may form.

Further, in the second prior art example, only the outline, or the surface coating, of the handle is modified to fit a user's hand. That is, the metal core of the handle cannot be reshaped. It is thus impossible to subject the handle to a large-scale reshaping, which includes bending and twisting. In this regard, only limited reshaping is allowed for this handle.

### SUMMARY OF THE INVENTION

Accordingly, it is an objective of the present invention to provide a handle of a cutting device that is formed of shape memory resin and is easily reshaped as desired.

It is another objective of the present invention to provide a handle of a cutting device that is formed of shape memory resin and suppresses formation of a shrinkage cavity when the handle is molded.

To achieve the foregoing and other objectives and in accordance with the purpose of the present invention, the invention provides a handle of a cutting device that is formed of shape memory resin. The handle has an assisting portion that makes it easy to reshape the handle.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a side view showing a razor handle of a first embodiment according to the present invention;

FIG. 1(b) is a partially cut-away, cross-sectional view showing the razor handle of FIG. 1(a);

FIG. 2 is a perspective view showing the razor handle of FIG. 1(a);

FIG. 3(a) is a side view showing a razor handle of a second embodiment according to the present invention;

FIG. 3(b) is a partially cut-away, cross-sectional view showing the razor handle of FIG. 3(a);

FIG. 4 is a side view showing a razor handle of a third embodiment according to the present invention;

FIG. 5(a) is a front view showing a T-shaped razor's handle of another embodiment according to the present invention;

FIG. 5(b) is a cross-sectional view taken along line 5b-5b of FIG. 5(a);

FIG. 6(a) is a side view showing a razor handle of another embodiment according to the present invention; and

FIG. 6(b) is a partially cut-away, cross-sectional view showing the razor handle of FIG. 6(a).

### DETAILED DESCRIPTION OF THE PREFERRED EMBODIMENTS

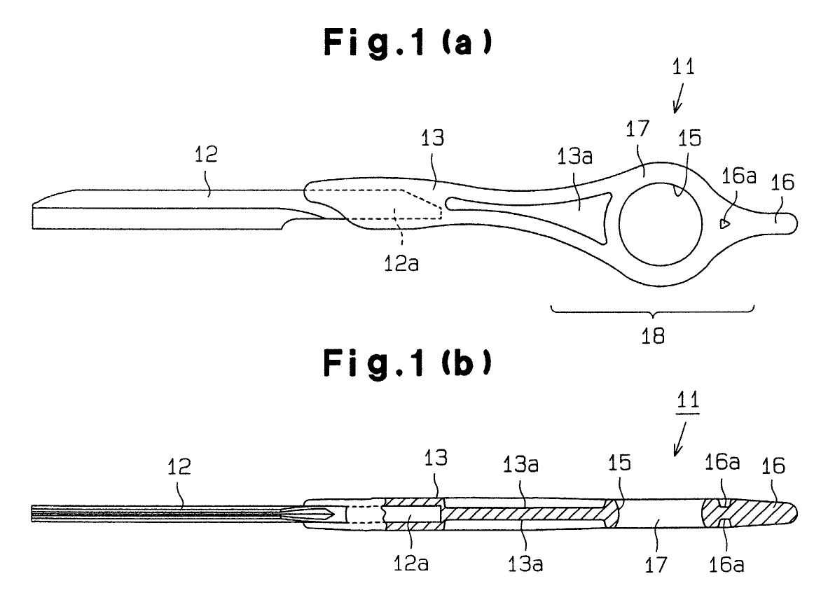

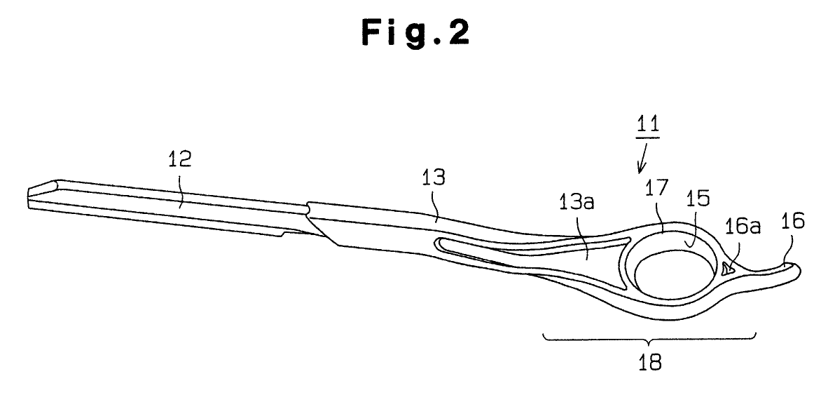

A first embodiment of the present invention will now be described with reference to FIGS. 1 and 2.

As shown in FIGS. 1(a) and 1(b), a razor holder 11 has an attachment member 12 and a handle 13. A blade 10 is attached to the attachment member 12. The handle 13 is formed of shape memory resin (a product of Mitsubishi Heavy Industries, Ltd.).

The distal end of the handle 13 is formed integrally with a base 12a of the attachment member 12 through insert molding. A substantially circular, finger support hole 15 extends through the handle 13 at a position near the opposite end, or the basal end, of the handle 13. The user holds the handle 13 with a finger held in the finger support hole 15. The handle 13 also includes a finger support 16, which is located further basal from the finger support hole 15. That is, the finger support 16 projects integrally from the basal end of the handle 13 in a longitudinal direction of the handle 13.

If a side of the handle 13 that corresponds to a cutting edge of the blade 10, which is attached to the attachment member 12, is defined as “a face” of the handle 13, the other side of the handle 13 is defined as “a back” of the handle 13. Thus, hereinafter, the dimension between the face and the back of the handle 13 is referred to as “a width” of the handle 13. Further, the distance between opposite sides of the handle 13 as viewed in a direction perpendicular to the surface of FIG. 1(a) is referred to as “a thickness” of the handle 13.

As shown in FIG. 1(a), the width of the handle 13 becomes gradually larger from a longitudinal intermediate section of the handle 13 toward a periphery 17 of the finger support hole 15. A width of the finger support 16 becomes gradually smaller from the periphery 17 of the finger support hole 15 toward the end of the finger support 16.

In other words, the handle 13 includes a holding portion 18 with an increased width for making it easy to hold the holder 11. The holding portion 18 mainly includes a section of the handle 13 through which the finger support hole 16 extends.

A pair of first recesses 13a are formed in opposite sides of the handle 13. More specifically, each first recess 13a extends along the intermediate section of the handle 13 from a corresponding portion of the holder 18 toward the distal end of the handle 13. The first recesses 13a make it easy to reshape the handle 13 at a predetermined temperature. Further, a pair of second recesses 16a are formed in opposite sides of the finger support 16 at positions near the finger support hole 15. The second recesses 16a make it easy to reshape the finger support 16 at a predetermined temperature. In other words, the first and second recesses 13a, 16a function as assisting portions when the handle 13 and the finger support 16 are reshaped. Further, the thickness of the remainder of the handle 13, which does not include the first recesses 13a or the second recesses 16a, is substantially uniform.

In addition, since the handle 13 has the first recesses 13a and the second recesses 16a, corresponding cross-sectional areas of the holding portion 18 of the handle 13 is substantially reduced. Thus, when the handle 13 is formed through, for example, injection molding, formation of a shrinkage cavity is suppressed. More specifically, when the handle 13 is molded from shape memory resin, molten resin rapidly solidifies at a position corresponding to a section of the handle 13 that has a relatively small cross-sectional area. In contrast, the molten resin takes a relatively long time to solidify at a position corresponding to a section that has a relatively large cross-sectional area. Accordingly, a shrinkage cavity is more likely to form in a section of the handle 13 that has a relatively large cross-sectional area than a section of the handle 13 that has a relatively small cross-sectional area. That is, although the width of the holding portion 18 is relatively large, the first recesses 13a and the second recesses 16a suppress formation of a shrinkage cavity in the holding portion 18.

Further, the first recesses 13a and the second recesses 16a are located adjacent to the periphery 17 of the finger support hole 15. In other words, the first and second recesses 13a, 16a are located relatively close to the finger support hole 15. As described, the handle 13 is easily reshaped at positions corresponding to the first recesses 13a and the second recesses 16a. Thus, a section of the handle 13 near the finger support hole 15 is easily reshaped while maintaining the shape of the finger support hole 15 as circular. That is, the locations of the first recesses 13a and the second recesses 16a are advantageous for maintaining the circular shape of the finger support hole 15. If the first recesses 13a and the second recesses 16a were not located near the finger support hole 15, it would be difficult to reshape the holding portion 18, and the circular shape of the finger support hole 15 would be modified.

The operation of the razor of the first embodiment will now be described.

First, the handle 13 is immersed in hot water. The handle 13 is thus heated to a temperature at which the handle 13 can be reshaped. When heating is completed, the handle 13 becomes soft like rubber such that a user can reshape the handle 13 as desired. As described, the first recesses 13a and the second recesses 16a reduce corresponding cross-sectional areas of the handle 13. This structure decreases reactive force generated against reshaping of the handle 13, thus making it easy to reshape the handle 13. Normally, shape memory resin becomes hard to reshape when the resin is cooled to a minimum value of a reshaping temperature range, which is a temperature range in which the resin can be reshaped. However, in the first embodiment, the handle 13 is easily reshaped due to the first recesses 13a and the second recesses 16a, even when the holder 11 is cooled to the minimum valve of the reshaping temperature range.

FIG. 2 shows the handle 13 that is twisted from the state of FIG. 1. Since the fist recesses 13a are formed in the handle 13, the handle 13 is easily twisted or bent. In addition, the second recesses 16a in the finger support 16 of the holding portion 18 make it easy to reshape the section of the finger support 16 near the second recesses 16a.

After the handle 13 is reshaped as desired at a temperature at which the handle 13 can be reshaped, the handle 13 is immersed in cold water, thus cooling the same to a temperature at which the razor is actually used. Alternatively, the handle 13 is cooled in the ambient air to the temperature at which the razor is actually used. In this manner, the handle 13 memorizes its shape. Accordingly, the shape of the handle 13 is fixed.

The handle 13 of the first embodiment has the following advantages.

(1) In the first embodiment, the first recesses 13a are formed in the handle 13, which is formed of shape memory resin. Further, the second recesses 16a are formed in the finger support 16, which is formed of shape memory resin. This structure reduces a corresponding cross-sectional area of the handle 13 and a corresponding cross-sectional area of the finger support 16. It is thus easy to reshape the handle 13 and the finger support 16. Particularly, the handle 13 may be easily subjected to a large-scale reshaping such as twisting and bending. Further, the handle 13 and the finger support 16 can be reshaped even at the minimum value of the reshaping temperature range.

(2) In the first embodiment, the first recesses 13a and the second recesses 16a reduce corresponding cross-sectional areas of the holding portion 18 of the handle 13. Thus, when forming the handle 13 through, for example, injection molding, formation of a shrinkage cavity is suppressed.

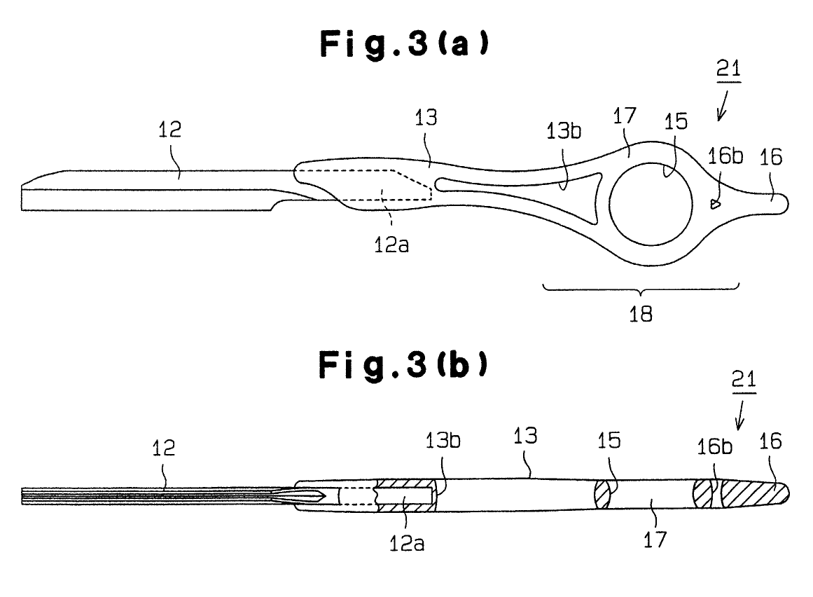

Next, a second embodiment of the present invention will hereafter be described with reference to FIG. 3. The second embodiment is a modification of the first embodiment. Same or like reference numerals are given to parts in FIG. 3 that are the same as or like corresponding parts of the first embodiment, and description thereof is omitted. In the following, only the difference between the second embodiment and the first embodiment will be described.

A razor holder 21 of the third embodiment includes a first through hole 13b and a second through hole 16b, instead of the first recesses 13a and the second recesses 16a of the first embodiment. More specifically, as shown in FIGS. 3(a) and 3(b), the first through hole 13b extends through the handle 13 at the holding portion 18, which extends from the longitudinal intermediate section of the handle 13 to the periphery 17 of the finger support hole 15. In other words, the first through hole 13b extends along the intermediate section of the handle 13 from a corresponding portion of the holding portion 18 toward the distal end of the handle 13. The second through hole 16b extends through the handle 13 at the holding portion 18, in the vicinity of the finger support 16.

Accordingly, in the handle 13 of the razor holder 21 of the second embodiment, the first through hole 13b and the second through hole 16b reduce corresponding cross-sectional areas of the holding portion 18, as compared to the first recesses 13a and the second recesses 16a of the first embodiment. As a result, the handle 13 of the second embodiment is further easily reshaped, thus effectively preventing formation of a shrinkage cavity.

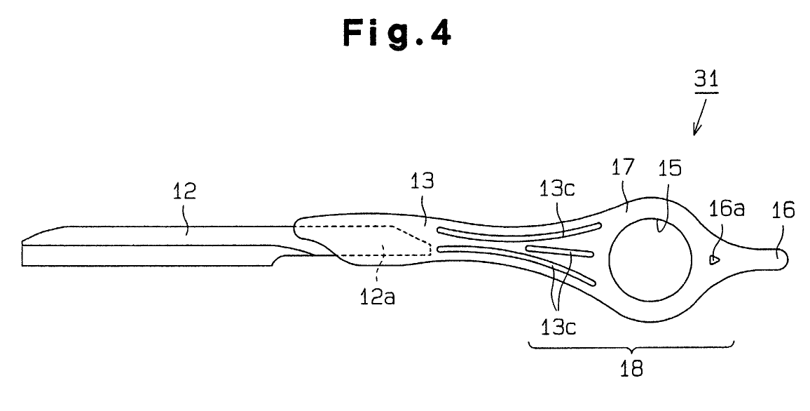

Next, a third embodiment of the present invention will hereafter be described with reference to FIG. 4. The third embodiment is a modification of the first embodiment. Same or like reference numerals are given to parts in FIG. 4 that are the same as or like corresponding parts of the first embodiment, and description thereof is omitted. In the following, only the difference between the third embodiment and the first embodiment will be described.

A razor holder 31 of the third embodiment has a plurality of slits 13c, instead of the first recesses 13a of the first embodiment. More specifically, as shown in FIGS. 4(a) and 4(b), each slit 13c extends longitudinally in the holding portion 18, which extends from the longitudinal intermediate section of the handle 13 to the periphery 17 of the finger support hole 15. The slit 13c thus forms an opening in the handle 13. The slits 13c that are located at opposite sides of the intermediate slit 13c extend from corresponding positions of the holding portion 18 toward the distal end of the handle 13.

Accordingly, also in the handle 13 of the razor holder 31 of the third embodiment, the slits 13c reduce corresponding cross-sectional areas of the holding portion 18, thus ensuring the same operations and advantages as those of the first embodiment.

It should be apparent to those skilled in the art that the present invention may be embodied in many other specific forms without departing from the sprit or scope of the invention. Particularly, it should be understood that the invention may be embodied in the following forms.

In the handle 13 of the third embodiment, which is shown in FIG. 4, the slits 13c may be replaced by a plurality of elongated grooves. If this is the case, the grooves are formed in the opposite sides of the holding portion 18 of the handle 13. Each groove has a bottom.

In the first embodiment, a single first recess 13a and a single second recesses 16a may be formed only in one side of the handle 13. In the same manner, if the slits 13c of the third embodiment are replaced by the elongated grooves, the grooves may be formed only in one side of the handle 13.

In the first embodiment, the handle 13 may be modified to include only the first recesses 13a or the second recesses 16a. Similar modification may be made to the second or third embodiment.

In the first to third embodiments, the handle 13 includes both the finger support hole 15 and the finger support 16. However, at least one of the finger support hole 15 and the finger support 16 may be omitted.

In the illustrated embodiments, the finger support 16 may have a slit or a groove.

In the third embodiment, a single slit 13c may be formed in the handle 13.

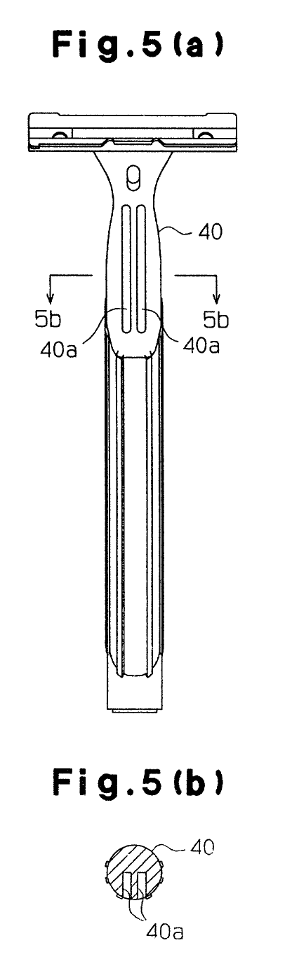

As shown in FIG. 5, the present invention may be applied to a T-shaped razor. More specifically, the razor includes a handle 40, and a plurality of elongated grooves 40a extend longitudinally in the handle 40. Each groove 40a functions as an assisting portion when the handle 40 is reshaped. In this structure, the handle 40 of the T-shaped razor is easily reshaped, like the handle 13 of the first embodiment.

Alternatively, a recess may replace the grooves 40a of the handle 40, which are shown in FIG. 5(a). More specifically, the depth of the recess is smaller than that of the grooves 40a, and the bottom area of the recess is larger than that of the grooves 40a. Further, a through hole or a slit may be formed in the handle 40.

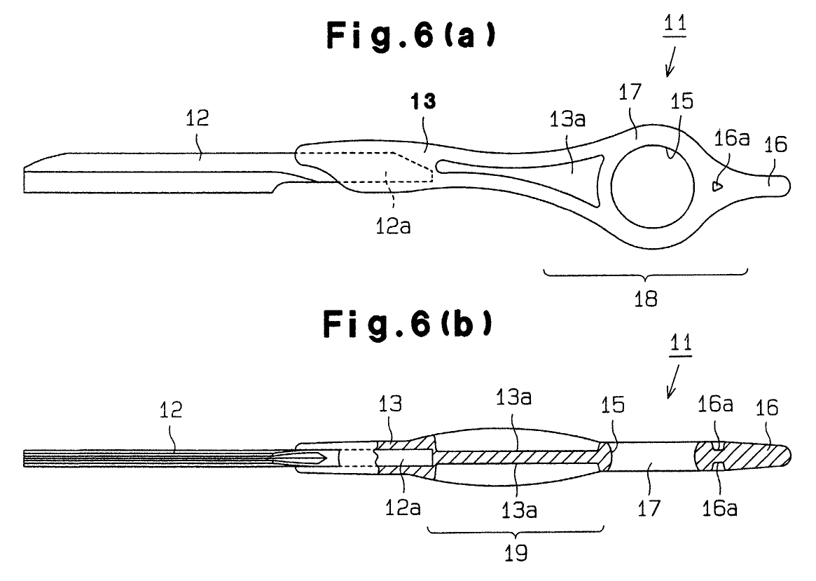

In the first embodiment, the holding portion 18 includes the first recesses 13a, each of which functions as an assisting portion when the handle 13 is reshaped. However, as shown in FIGS. 6(a) and 6(b), the handle 13 may include a thick portion 19. The thickness of the thick portion 19 is larger than that of the remainder of the handle 13. The first recesses 13a, or the assisting portions, are formed in the thick portion 19. Further, the thick portion 19 in which the first recesses 13a are formed may be located at a position corresponding to the holding portion 18. This structure reduces a cross-sectional area of the thick portion 19, regardless of the thickness of the thick portion 19. Accordingly, the handle 13 is easily reshaped at a temperature at which the handle 13 can be reshaped. Further, formation of a shrinkage cavity in the thick portion 19 is suppressed. Similar modification may be made to the second or third embodiment.

Therefore, the present examples and embodiments are to be considered as illustrative and not restrictive and the invention is not to be limited to the details given herein, but may be modified within the scope and equivalence of the appended claims.

1. A handle of a cutting device, wherein the handle is formed of shape memory resin and has an assisting portion that makes it easy to reshape the handle.

2. The handle of a cutting device as set forth in claim 1, wherein the assisting portion prevents a shrinkage cavity from being formed when the handle is reshaped.

3. The handle of a cutting device as set forth in claim 1, wherein the handle has a holding portion that is held by a user when holding the handle, and the assisting portion is located in the holding portion.

4. The handle of a cutting device as set forth in claim 1, wherein the handle has a thick portion, and the assisting portion is located in the thick portion.

5. The handle of a cutting device as set forth in claim 1, wherein the handle has a finger support hole, and the assisting portion is located near the finger support hole.

6. The handle of a cutting device as set forth in claim 1, wherein the handle has a finger support, and the assisting portion is located near the finger support.

7. The handle of a cutting device as set forth in claim 1, wherein the assisting portion is a recess.

8. The handle of a cutting device as set forth in claim 1, wherein the assisting portion is a through hole.

9. The handle of a cutting device as set forth in claim 1, wherein the assisting portion is a slit.

10. The handle of a cutting device as set forth in claim 1, wherein the assisting portion is a groove.

11. A handle of a cutting device, wherein the handle is formed of shape memory resin and comprises:
a holding portion, which is held by a user when holding the handle; and
a plurality of recesses, which are formed in the holding portion and make it easy to reshape the handle.

12. The handle of a cutting device as set forth in claim 11, wherein the handle has a finger support hole, and the recesses are located near the finger support hole.

13. The handle of a cutting device as set forth in claim 11, wherein the handle has a finger support, and the recesses are located near the finger support.
